(19) United States
(12) Patent Application Publication
(10) Pub. No.: US 2021/0022463 A1
(43) Pub. Date: Jan. 28, 2021

(54) Combination Umbrella and Adapter

(71) Applicant: Robin George Newcombe, Thornton (AU)

(72) Inventor: Robin George Newcombe, Thornton (AU)

(21) Appl. No.: 16/898,297

(22) Filed: Jun. 10, 2020

Related U.S. Application Data
(60) Provisional application No. 62/878,065, filed on Jul. 24, 2019.

(51) Int. Cl. A45B 3/00; F16M 13/04; H04M 1/04

(52) U.S. Cl. CPC A45B 3/00; F16M 13/04; A45B 25/14; A45B 2200/109; H04M 1/04

(57) ABSTRACT

An umbrella has a handle with a top end and a bottom end, wherein a shaft extends from the top end of the handle to a canopy, and a quick-release mounting feature is disposed on the handle.

### CROSS-REFERENCE TO RELATED APPLICATIONS

This application for a utility patent claims the benefit of U.S. Provisional Application No. 62/878,065, filed Jul. 24, 2019.

### BACKGROUND OF THE INVENTION

### Field of the Invention

This invention relates generally to umbrellas, and more particularly to a combination umbrella and adapter for attachment to a device.

### Description of Related Art

There are numerous examples in the prior art of a device having a clamp mechanism for holding a mobile device, that is capable of attachment to a tripod or elongated stick, i.e., as in a selfie stick. Other mechanisms for attachment to a mobile device have also been provided, e.g., an adhesive instead of a clamp. These devices are mainly used on the go, meaning that there may be limited space or hand availability for other tools, e.g, an umbrella, wallet, etc. There exists a need in the prior art for a quick way to take a long-distance selfie without the need for additional tools.

Umbrellas are of course well-known in the prior art, and a common issue is also space-saving, or trying to maneuver multiple tools/devices while still using an umbrella. Therefore, the ability to attach an umbrella to a stable surface or another device is desirable.

The prior art teaches mobile device attachments and umbrellas. However, the prior art does not teach a combination umbrella and adapter for attaching the umbrella to other objects and devices, especially related to the field of cameras. The present invention fulfills these needs and, provides further advantages as described in the following summary.

### SUMMARY OF THE INVENTION

The present invention teaches certain benefits in construction and use which give rise to the objectives described below.

The present invention, provides an umbrella comprising a handle having a top end and a bottom end, wherein a shaft extends from the top end of the handle to a canopy, and wherein the umbrella further comprises a quick-release mounting feature disposed on the handle.

A primary objective of the present invention is to provide a combination umbrella and adapter having advantages not taught by the prior art.

Another objective is to provide a combination umbrella and adapter that saves space by being capable of attachment, to other surfaces and devices.

A further objective is to provide a combination umbrella and adapter that that is sized to receive a standard mobile device attachment, e.g., a tripod, selfie clamps, etc.

Other features and advantages of the present invention will become apparent from the following more detailed description, taken in conjunction with the accompanying drawings, to which illustrate, by way of example, the principles of the invention.

### BRIEF DESCRIPTION OF THE DRAWINGS

The accompanying drawings illustrate the present invention. In such drawings:

FIG. 1 is an exploded perspective view of a combination umbrella and adapter used with a smart phone clamp for holding a smart phone, according to one embodiment of the present invention;

FIG. 2 is a perspective view of the handle partially broken away to illustrate internal components;

FIG. 3 is a perspective view of the combination illustrating the smart phone held by the smart phone clamp for taking selfie photographs; and

FIG. 4 illustrates the combination mounted on a tripod in an alternative use of the present invention.

### DETAILED DESCRIPTION OF THE INVENTION

The above-described drawing figures illustrate the invention, a combination umbrella and adapter 10. The combination 10 includes an adapter 28 in the form of a quick-release mounting feature that may be used for a variety of tasks, as discussed in greater detail below.

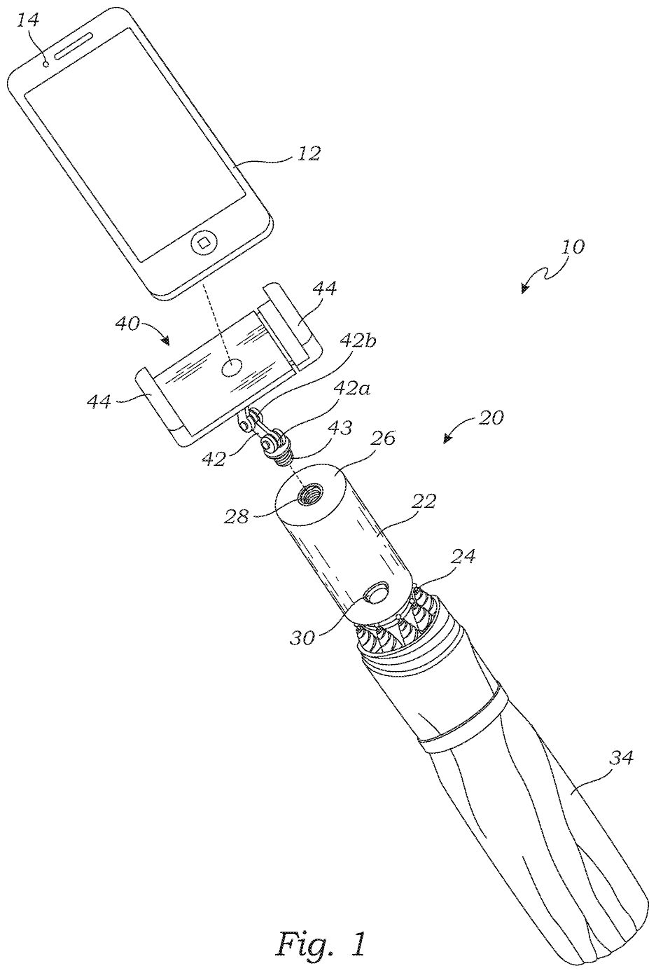

FIG. 1 is an exploded perspective view of one embodiment of the combination umbrella and adapter 10 that is useful for taking selfie photographs. As shown in FIG. 1, the combination 10 includes an umbrella 20 having the quick-release mounting feature 28 that may be used to removably mount a smart phone clamp 40 for holding a smart phone 12. The smart phone clamp 40 is adapted to be removably mounted on the quick-release mounting feature 28, and then clamped onto the smart phone 12, so that the smart phone 12 may be held at a distance from the holder for taking selfie photographs, or other photographs that require a camera 14 of the phone 12 to be held at a distance (e.g., from a raised elevation over other people, over cliffs and other dangerous locations, etc.). In some embodiments, the components may be adapted to instead hold a tablet, camera, or other device, discussed in greater detail below.

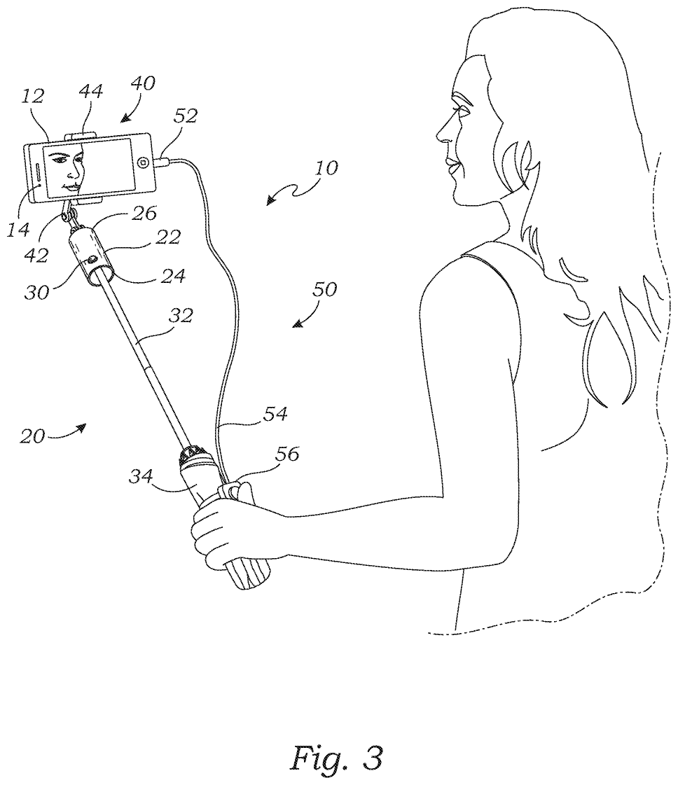

As show in FIG. 1, the umbrella 20 includes a handle 22 having a top end 24 and a bottom end 26 A shaft 32 (visible in FIG. 3) extends upwardly from the top end 24 of the handle 22 for supporting a canopy 34. The umbrella 20 is generally similar to prior art umbrellas, and may include tension springs, a runner, or any other actuating component (not shown herein) which is commonly constructed on/inside an umbrella, for extending and retracting the length of the umbrella 20. The canopy 34 forms the sheltering “tent” part of the umbrella 20 that opens into an arc or dome shape and protects a user from the rain, sun, etc. The umbrella 20 may be opened via a press release mechanism 30, a latch, by being manually extended, or using any other mechanism known in the art. In this embodiment, the shaft 32 (shown in FIG. 3) may be extended, but in other embodiments, is may be constructed of a single piece of fixed length. The canopy 34 may be supported and collapsed using a variety of extensions, joints, tubes. etc. (not shown), as is well-known to those skilled in the art.

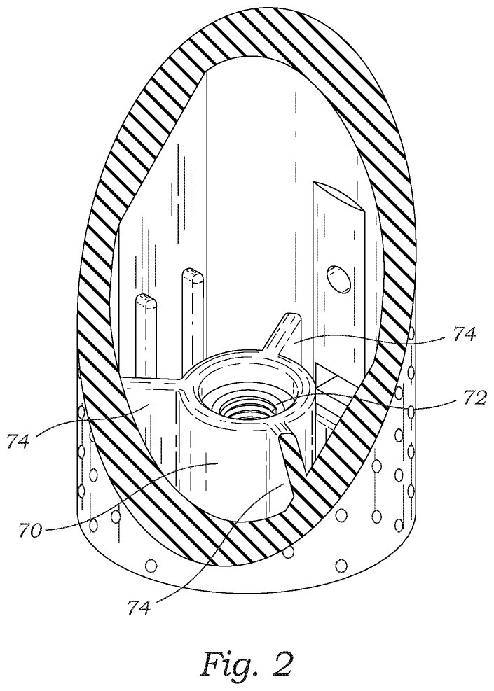

In this embodiment, the handle 22 includes the quick-release mounting feature 28 in the bottom end 26 of the handle 22; however, the quick-release mounting feature 28 may be positioned on any suitable surface of the handle 22, or elsewhere on the umbrella 20. The handle 22 may be constructed of a variety of materials, such as rubber, plastic, wood, etc. In some embodiments, the handle 22 may include an attachment loop (not shown) for hanging the umbrella 20 on a hook, wrist, etc. The attachment loop may be nylon, leather, rubber, or any material deemed desirable by those skilled in the art. The handle 22 may further be internally reinforced, shown in FIG. 2 and discussed below.

As shown in FIG. 1, the quick-release mounting feature 28 is an internally threaded bore shaped and sized to receive various common adapters and other items, such as a camera tripod, selfie stick/POV pole, and others, some of which are listed below. The bore may have a diameter of ¼ inch; however, other diameters may be selected, such as the second most-common ⅜ inch, or as needed for alternative or new types of adapters. In some embodiments, the quick-release mounting feature 28 may be in the form of a latch, or an external mount, a clamp, or any other adapter attachment which is commonly known in the art. The umbrella 20 may be manufactured and sold in a package with optional adapters, or be sold separately, with just the quick-release mounting feature 28.

The smart phone clamp 40 is adapted to removably hold a mobile phone 12, such as via clamps or other removable attachment mechanisms commonly used on a selfie-stick. in this embodiment, the smart phone clamp 40 includes a jointed base 42 that includes an externally threaded post 43 at one end, and spring biased clamps 44 at the other, to secure a mobile phone 12 onto the umbrella 20. The jointed base 42 may include a first pivot 42a and a second pivot 42b for adjusting the position of the clamps 44 with respect, to the threaded post 43.

While one embodiment of the smart phone clamp 40 is illustrated, the particular construction of the smart phone clamp 40 may obviously vary a great deal according to the particular desires of the product designer. For example, the jointed base does not require joints, it could be a solid piece that is shaped into a suitable shape for properly holding the smart phone 12. The particular shape and construction may also vary depending upon the location of the quick-release mounting feature 28, and such alternatives should be considered, within the scope of the present invention, so long as it, operates to suitably hold the smart phone 12 or other form of device. Examples of other devices that may be used include tablets, cameras, a GPS device, etc. Further examples of possible mounts for these devices are discussed below.

FIG. 2 is a perspective view of the handle 22 partially broken away to illustrate internal components. As shown in FIG. 2, in this embodiment, the quick-release mounting feature 28 is in the form of an internally threaded bore comprising a threaded metal insert 72 mounted within a cylindrical receiver 70. A plurality of radially-spaced reinforcement ribs 74, in this embodiment three, connect the cylindrical receiver 70 to an inner wall of the handle 22. Other shapes and quantities of the reinforcement ribs 74 may be constructed, as-needed to reinforce the handle 22 and adapter 28.

FIG. 3 is a perspective view of the combination 10 illustrating the smart phone clamp 40 mounted on the umbrella 20, and illustrating the smart phone 12 held by the smart phone clamp 40 for taking selfie photographs. As shown in FIG. 3, a user may hold the canopy 34 end of the umbrella 20 so that the smart phone 12 is held a distance from the user, and then actuate a trigger device 50 to capture an image without having to hold the mobile phone 12 in his or her hand.

As shown in FIG. 3, in this embodiment the trigger device 50 is for remotely triggering a camera 14 of the phone 12. in one embodiment, the trigger device 50 includes a first end connector 52 that operably plugs into the smart phone 12, while a second end 54 is connected to a control mechanism 56 (e.g., a button or other form of switch). While one embodiment of the trigger device 50 is illustrated, those skilled in the art may devise alternative devices, such as, e.g., a wireless (e.g., Bluetooth®) trigger, or any other mechanism known in the art. In some embodiments, the connector may be integrally constructed within the shaft 32, with the first end connector 52 exposed, and the control mechanism 56 operably mounted on the umbrella 20.

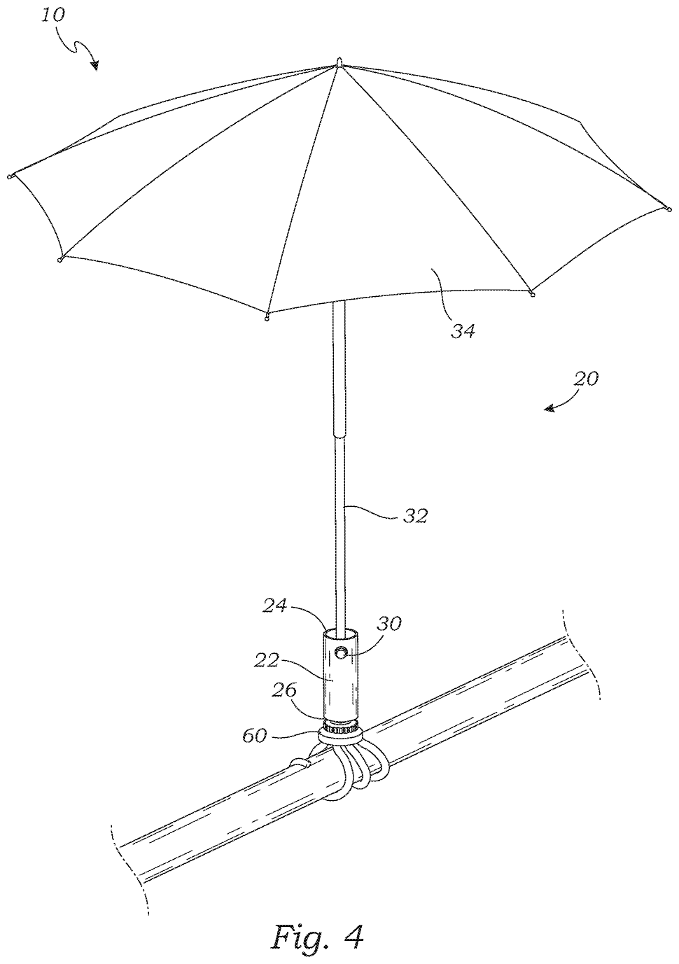

The quick-release mounting feature 28 may also be used for a wide variety of other functions, in addition to rendering the umbrella 20 useful as a selfie stick. For example, FIG. 4 illustrates the umbrella 20 being mounted on a tripod 60 that enables the umbrella 20 to be removably secured in a desired position and orientation. In this embodiment, the tripod 60 of FIG. 4 has flexible legs 62 and may be attached to a surface or mount such as a fence, stroller, etc., such that when the umbrella 20 is attached to the tripod 60, it may provide shade or protection from inclement weather hands-free. Other types of tripods may be used, such as a fixed-leg tripod, or the quick-release mounting feature 28 may also accept similar adapters such as a GoPro® mount, etc. Further, various adapters may assist a user in navigating via GPS hands-free, or using any other type of tool which may be attached to an adapter capable of engaging, with the quick-release mounting feature 28. While examples of adapters and uses thereof are provided above, it should be understood that any type of capable adapter may be used in conjunction with the umbrella and quick-release mounting feature 10.

As used in this application, the words “a,” “an,” and one are defined to include one or more of the referenced item unless specifically stated otherwise. The terms “approximately” and “about” are defined to mean +/−10%, unless otherwise stated_{—} Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application. While the invention has been described with reference to at least one particular embodiment, it is to be clearly understood that the invention is not limited to these embodiments, but rather the scope of the invention is defined by claims made to the invention.

What is claimed is:

1. An umbrella comprising:
a handle having, a top end, a bottom end;
a shaft extending from the top end of the handle to a canopy; and
a quick-release mounting feature disposed on the handle.

2. The umbrella of claim 1, wherein the quick release mounting feature is in the form of an adapter having an internally threaded bore.

3. The umbrella of claim 2, wherein the internally threaded bore has a diameter of either ¼ inch or ⅜ inch.

4. The umbrella of claim 2, further comprising a trigger device for remotely triggering a camera.

5. The umbrella of claim 2, further comprising a tripod adapted for attachment to the quick-release mounting feature.

6. An umbrella for removably holding a smart phone, the umbrella comprising:
a handle having a top end, a bottom end;
a shaft extending from the top end of the handle to a canopy;
a quick-release mounting feature disposed on the handle, wherein the quick-release mounting feature is in the form of an internally threaded bore; and
a smart phone clamp having adjustable clamps for clamping the smart phone, and an externally threaded post for threaded engagement with the quick release mounting feature of the umbrella.

7. The umbrella of claim 6, wherein the internally threaded bore has a diameter of either ¼ inch or ⅜ inch.

8. The umbrella of claim 6, further comprising a trigger device for remotely triggering a camera of the smart phone.

9. The umbrella of claim 6, further comprising a tripod adapted for attachment to the quick-release mounting feature.
